(19) United States
(12) Patent Application Publication
(10) Pub. No.: US 2006/0274614 A1
(43) Pub. Date: Dec. 7, 2006

(54) Management of use of information that is recorded on an optical disk

(75) Inventors: Antonius Hermanus Maria Akkermans, Eindhoven (NL); Johan Paul Marie Gerard Linnartz, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,434

(22) PCT Filed: Aug. 27, 2004
(86) PCT No.: PCT/IB04/51584

§ 371 Date: Mar. 2, 2006

(30) Foreign Application Priority Data
Sep. 9, 2003 (EP) 031033319

(51) Int. Cl. G11B 20/10

(52) U.S. Cl. 369/47.22

(57) ABSTRACT

PHNL031053 An apparatus for processing data from an optical disk (20) generates a data signal by decoding information from the track (21) and a track position signal that is indicative of the radial position and/or depth of the track (21), and/or jitter in the position of edges of bit signals from the track (21). From the track position signal, values of plurality of characteristic measures are computed so that the computed values are substantially invariant under a phase of disk rotation, for example by determining the absolute values of Fourier transform components at multiples of the revolution frequency. Conditional use of the data signal is controlled dependent on the values computed for the characteristic measures. In one embodiment access is granted when the computed values match predetermined values for the disk. In another embodiment it is ensured that the disk is not removed from the apparatus during a session, by comparing a values that is sensitive to eccentricity with a value determined at the start of the session.

The invention relates to management of use of information that is recorded on an optical disk, including management such as copy control and/or access control.

European Patent application No. 706174 describes a method and system for preventing illegal copying of disks. This patent application describes the use of physical features, such as the angular location of data blocks on the disk, variations in track displacement relative to the centre of the disk and pit depth to distinguish “legal” disks from “illegal” copy disks. A legal disk contains a table, with entries for a number of data blocks, the entries containing the address of the block and values of the angular location, track displacement and/or pit depth of the part of the track that contains the block. The table is protected against tampering. The basic idea is that, when the data blocks from the disk are copied to another disk, it is impossible to ensure that one or more of these physical features have the same value for each block on the copied disk.

Accordingly, it is made impossible to read and/or copy any disk of which the actual values of the physical properties do not correspond to the values stored in the table. In addition it is made impossible to use any disk onto which data has been copied without copying the table as well.

Prior to reading and/or copying a player senses the angular location, track displacement and/or pit depth of a plurality of blocks and compares the sensing results with the values stored in the table. When the sensing results differ from the values in the table for a significant number of blocks, the player blocks reading and/or copying.

The disclosed technique has some drawbacks. First of all the verification that the physical properties have the stored value requires access to the table from the outset, which means that all computations have to be protected against tampering. It is not possible to perform the bulk of the computations for verification with unprotected software. Verification requires the table to be read from the disk first. The table has to have a significant size.

Secondly, verification requires combined access to signals that are normally processed separately in disk players. The address signals and track displacement signals for example are not normally available together in existing integrated circuits. As a result, the hardware of disk players has to be fundamentally adapted in order to ensure protection against playing illegal copies.

Thirdly, in order to ensure the presence of sufficiently recognizable physical features, the disclosed technique requires mastering/recording equipment that intentionally creates significant variations in the physical properties, for example by varying the angular speed during recording or by wobbling the track displacement during recording. Such equipment is more expensive and reliance on such equipment creates the risk that copiers acquire similar equipment, which would enable them to make undistinguishable copies.

Fourthly, in case of a rewriteable disk movement of addressed blocks on the disk would disable access.

Among others, it is an object of the invention to provide for a method to manage the use of information that is recorded on an optical disk, wherein the method does not require player architecture to be fundamentally adapted.

Among others, it is an object of the invention to provide for a method to manage the use of information that is recorded on an optical disk, which permits a part of the computations required for verification to be performed in the same way for different disks, independent of disk specific data.

Among others, it is an object of the invention to provide for a method to manage the use of information that is recorded on an optical disk, wherein a sensitive identification of the disk can be realized without using special mastering/recording equipment.

According to one aspect of the invention a number of characteristic measures are computed from for the shape of track position signal that is indicative of the radial position and/or depth of the track, and/or jitter in edges of bit signals from the track. Characteristic measures are used that are substantially invariant under rotation of the disk, such as for example the absolute value of the Fourier transform of the track position signal at various frequencies. However, other invariant measures may be used, such as maxima of correlations with template functions, computed as a function of a shift of the template relative to the track position signal. In fact the absolute value of a Fourier transform at any frequency is and example of such a maximum, with a cosine function used as template function.

Preferably, values of the Fourier transform of the track position signal over a plurality of revolutions at harmonics of the frequency of revolution of the disk are used as characteristic measures. More generally, the characteristic measures preferably filter out frequency components from the track position signal that are not harmonics of the frequency of revolution from the position signal taken from a plurality of revolutions, for example from ten or more revolutions. Thus, the characteristic measures are selectively sensitive to two-dimensional properties of the disk, which cause repeating effects in successive revolutions. It has been found that this makes it possible to distinguish disks by characteristic features whose value is determined by accident during manufacture, without intentionally introducing deviations.

Preferably, a frequency component of the position signal at the fundamental frequency of revolution is suppressed in the characteristic measures. It has been found that effects of eccentricity of the disk does not significantly affect verification. Preferably, frequency components of the position signal at higher order harmonics of the frequency of revolution, whose period lengths correspond to a wavelength on the disk that is not significantly longer than the thickness of scratches are suppressed in the characteristic measures. Thus, disk verification is not significantly affected by scratches.

In another embodiment, the value of the amplitude of the frequency component of the position signal at the fundamental frequency of revolution is used to detect whether the disk has been taken out of the player and placed back. The result of this detection is used to condition use of the disk. Thus it becomes possible to support single session licenses for use of a disk.

These and other objects and advantageous aspects of the invention will be described using the following figures.

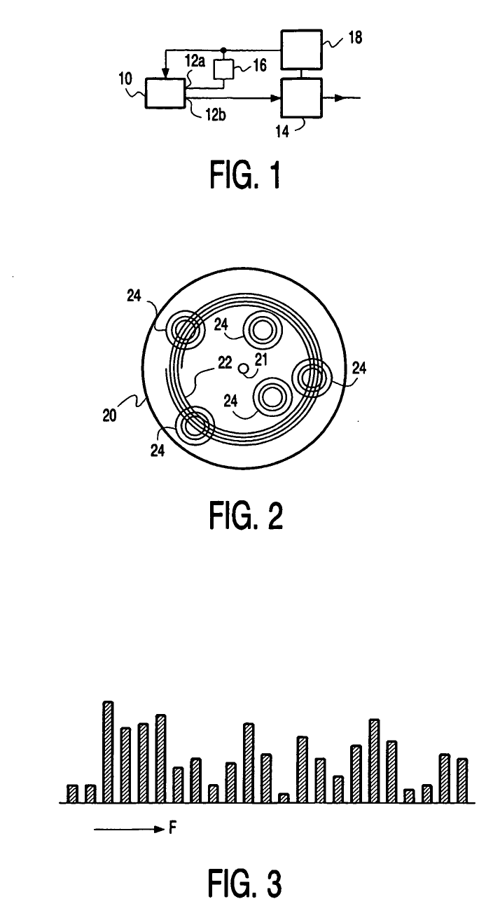

FIG. 1 shows a disk player

FIG. 2 shows a disk

FIG. 3 shows harmonic components from a Fourier transform

FIG. 1 shows a disk player. The player contains a reading unit 10, a data processing unit 14, a feedback control circuit 16 and a signature computation unit 18. Reading unit 10 has outputs 12a,b for data and positioning information respectively. Output for data 12a is coupled to data processing unit 14 and output for positioning information 12b is coupled to feedback control circuit 16. Feedback control circuit 16 has an output coupled to both a feedback input of reading unit 10 and an input of signature computation unit 18.

Signature computation unit 18 has an output coupled to data processing unit 14.

FIG. 2 illustrates a disk 20 for use in reading unit 10. Disk 20 contains a central hole 21 and a track 22 that spirals around central hole 21 in successive revolutions. Track 22 contains data that can be read optically, for example in the form of pits with variable length along the track.

In operation disk 20 is inserted in reading unit 10. Reading unit 10 rotates disk 20 substantially around its central hole 21 and uses a read head (not shown) to read the data from track 22 on the disk. Reading unit 10 outputs the data and a positioning information signal, which provides information about the position of the head relative to the track in radial direction on the disk and/or in a direction perpendicularly to the disk (the focus direction). Feedback control circuit 16 receives the positioning information and uses this information to generate a feedback signal to make the read head follow the track in radial and/or depth direction.

Generally speaking the read head steadily moves radially towards or away from central hole 21, at a constant distance from the surface of disk 20. In addition, however the read head has to make other corrective movements, due, among others, that mechanical disturbances of the player, imperfections of the player and irregularities of disk 20.

Part of the irregularities of disk 20 may be due to eccentricity of central hole 21 relative to the revolutions of the track, or intentional wobbling of the radial distance between the track and central hole 21. Other irregularities are not directly related to the track, these irregularities include scratches, unevenness in an optically transparent layer that covers disk 20 etc. Some of these regularities arise during use of disk 20, but others arise spontaneously during manufacturing of disk 20 and remain stable during use. Many of these stable irregularities extend over more than an insignificant area of the disk. FIG. 2 symbolically illustrates a number of irregularities 24, for example, in the form of unevenness in an optically transparent layer that covers disk 20. These irregularities may be used to verify the identity of individual disks, i.e. to distinguish an individual disk from other disks.

The advantage of using this type of signal is that it can generally easily be accessed without substantial circuit modifications, because this type of signal has to pass from the control circuitry to physical sensors or to physical actuators. Similarly, jitter in edges of bit signals from a track data sensor may be used (from the so-called “eye-pattern”). This jitter can be measured by counting the delay of the timing of these edges relative to a local clock with a stable frequency that on average is the same frequency of the bit signals.

To distinguish an individual disk from other disks signature computation unit 18 receives the feedback signal and uses the feedback signal to verify the identity of the disk. Signature computation unit 18 uses the result of verification to generate a control signal for data processing unit 14, in order to disable certain functions (such as copying, reproduction and/or decoding) when the verification indicates that there is an identity error.

Signature computation unit 18 receives the feedback signal obtained when following the track during a series of successive revolutions of the disk 20 within a predetermined band of within a predetermined distance range from the centre 21 of the disk, containing for example at least 10 an more preferably at least 20 track revolutions. The band may be read during normal use, while data processing unit 14 processes data from disk 20, but in an embodiment signature computation unit 18 controls reading unit 10 to move to the band specifically for verification purposes and to follow track 22 in the band, so as to receive the feedback signal.

In a first embodiment signature computation unit 18 computes the Fourier transform of the obtained signal and determines the amplitudes of the Fourier transform (the absolute value) at a plurality of frequencies that correspond to non-zero integer multiples of the rotation frequency of the disk. In principle, signature computation unit 18 may compute the Fourier transform from a set of samples of the feedback signal as a function of time within a time window, while reading unit 10 follows the track in the predetermined band. This can be done on the fly: signature computation unit 18 may compute the Fourier transform by computing respective Fourier transforms each of the feedback signal F(t) over a time interval T that corresponds to a single revolution, or an integer number of revolution, followed by summing of these respective Fourier transforms. Since the Fourier transform is needed only for integer multiples of the revolution period, the same transform coefficients are involved in each period.

Since signature computation unit 18 uses the Fourier transform only for integer multiples of the revolution period the feedback signals F(t) that occur at the same angle during successive revolutions of the disk may be summed over a number of revolutions of the disk to form a sum signal S(t) (in which t runs over an interval 0. T equal to one period of revolution T)
S(t)=ΣₙF(t+nT)

Here the sum over n runs over a number of revolutions, T being the duration of a revolution (it is assumed here that the number of revolutions is so small, say 10, that T does not vary appreciably). Since the comparison with the reference amplitudes is taken at multiples of the revolution signature computation unit 18 may compute the Fourier transform for the comparison from the sum signal S(t). Optionally signature computation unit 18 may use a weight function to weigh different periods differently in the sum to determined S(t).
S(t)=ΣₙW(t+nT)F(t+nT)

FIG. 3 shows the amplitudes of the Fourier transform of a feedback signal from a predetermined band in a histogram. In a typical example, the spectral density of the feedback signal is concentrated in a low frequency band with a bandwidth of 4 kHz, and the revolution frequency of the disk may be up to 100 Hz. In this example, signature computation unit 18 may obtain the amplitude of the Fourier transform at say 24 frequencies that are different non-zero integer multiples of the revolution frequency. It has been found that a distinction can be made between at least a hundred different disks with this number of amplitudes. Preferably the number of multiples of the revolution frequency that is used for detection is limited so that scratches on the disk do not contribute significantly to the amplitudes. Thus, for example, the 24h multiple of the revolution frequency corresponds to spatial frequency of 1.5 cm at the periphery of the disk for a disk with a diameter of 12 cm. This is well below the frequency of spectral components of the feedback signal due to scratches. By using no harmonics higher than for example the 24^{th} the effect of scratches on the disk can be suppressed.

In the first embodiment data processing unit 14 compares the computed amplitudes with a set of reference amplitudes stored in a memory. The reference amplitudes may be loaded into the memory for example from disk 20, where they are preferably stored in a tamper resistant way, for example in encoded with a secret key, or from an external source, such as a smart card or the Internet, when receiving a license. If the discrepancy between the calculated amplitudes and the reference amplitudes is above a threshold data processing unit 14 disables certain functions, such as copying or decryption of data from disk 20. Any way of comparing the amplitudes may be used, for example signalling that the discrepancy is too high when at the difference between the computed amplitude and the reference amplitude for least one frequency is in excess of a threshold for that frequency, of if a sum of deviations for different frequencies exceeds a threshold.

The amplitude of the Fourier transform of the feedback signal has been found to show a distinct peak at least at the revolution frequency. Therefore in an embodiment signature computation unit 18 determines the value of the revolution frequency from the Fourier transform, by selecting the frequency of a peak in the Fourier transform amplitude within an expectation range for the revolution frequency. As an alternative, reading unit 10 may be provided with a revolution indicator output, which generates a revolution signal each time the disk has made one revolution. In this case signature computation unit 18 determine select the revolution frequency from the revolution signal.

The amplitude of the peak in the Fourier transform at the revolution frequency strongly depends on eccentricity of the central hole in the disk and also on the way the disk is mounted in reading unit 10. When signature computation unit 18 supplies a signature to verify the identity of the disk, the amplitude of this peak is therefore preferably ignored in the comparison with the reference amplitudes.

In another embodiment, in contrast, the dependence on eccentricity is used as a way of ensuring that the disk is not removed from reading unit 10 during a session. This may be used for example to limit use of the disk to a single session, until the disk is taken out of reading unit 10.

In this case, for example, signature computation unit 18 computes the amplitude of the Fourier transform the first time when the disk is inserted after the start of a session. A session starts for example on reception of a license to play the disk (a license may be received for example in the form of an Internet signal from a source of licenses, or from a smart card inserted in the player).

In addition to the normal verification of the disk identity, data processing unit uses the amplitude of the first harmonic of the Fourier transform at the revolution frequency repeatedly during the session, to check that the disk has not been removed. Signature computation unit 18 computes the amplitude of the first harmonic from the feedback signal for a band of revolutions at the start of the session. Data processing unit 14 stores this amplitude at the start of the session. Subsequently, signature computation unit 18 repeatedly captures the feedback signal computes the amplitude of the first harmonic of the Fourier transform. Data processing unit 14 compares this amplitude with the stored amplitude and enables certain functions in data processing unit 14 only when the new amplitude does not differ more than a threshold amount from the stored amplitude. Of course the amplitudes of the other harmonics may be checked repeatedly as well.

The response function of feedback control unit 16 may be different for different player types. In an embodiment, measures are taken to avoid that this makes the reference amplitudes dependent on the player type. In this embodiment the feedback signal is normalized prior to comparison, in order to make the comparison independent of the type of player. Normalization may be realized by multiplying the measured amplitudes of the Fourier transform or of the reference amplitudes with weight factors, in order to correct for the properties of the specific player (both in terms of frequency dependence and a proportionality constant between the feedback signal and physical deviations on the disk). Alternatively, normalization may be performed prior to computing the Fourier transform, or amplitude normalization may be realized by comparing ratios between the amplitudes at different frequencies with reference values.

In a further embodiment, the effect of feedback control circuit 16 is eliminated during measurements for the purpose of disk verification. For example, the player may switch between a verification mode and a normal mode, the bandwidth of feedback control circuit 16 being set much lower in the verification mode than in the normal mode, to low value so that in the verification mode feedback control circuit 16 corrects for slow variations in radial displacement and/or track depth, such as those due to the spiralling of the tracks, but not for faster variations due to irregularities in disk 20. In this case, the track position output of reading unit 10 may be used to obtain signals from which the relevant shape of the tracks can be determined. Instead another sensor may be used to obtain information about the tracks, but of course it is preferred to use the output of reading unit 10 that is already available.

Preferably data representing the reference amplitudes for a particular disk is stored on the particular disk. In this case data processing unit 14 receives this data from the particular disk and writes the data to a reference memory. In an alternative embodiment the data about the reference amplitudes may be supplied to the player from outside, for example via the Internet or via a smart card, preferably in encrypted form, and loaded into reference memory after decryption in the player, using a protected key.

In an alternative embodiment data processing unit 14 uses the computed amplitude values as a key to decrypt data from the disk. Thus, no explicit reference values need to be supplied. For this purpose the data is encrypted using an encryption/decryption scheme arranged so that in which decryption succeeds when the decryption key is within a predetermined distance from a nominal decryption key. The invention is not particular to any specific implementation of such an encryption/decryption scheme, but it may be realized in a simple form, for example, by rounding the computed amplitudes, encrypting data a number of times, for decryption with a nominal (rounded) key and all keys that are within a maximum distance from the nominal key, and identifying during decryption which encrypted data leads to proper decryption with the computed key (e.g. by checking the value of decrypted test data).

In another embodiment the data processing unit comprises a key selection unit, arranged to select a key from a plurality of possible keys dependent on the computed values of the characteristic measures, the data processing unit receiving the selected key and decrypting at least part of the data using the selected key.

It should be appreciated that use of a Fourier transform and the amplitudes of this Fourier transform to control conditional use of the disk is only one embodiment of the invention. More generally any type of rotation invariant quantities may be used. Many examples of such quantities are possible.

For example, instead of the amplitudes of the Fourier transform, any rotation invariant functions of the values of the Fourier transform may be used to compute characteristic values (i.e. without taking absolute values). When the Fourier is written as
f(n)=∫dt S(t) exp(i2πnt/T)
for example, f(n)^{N/n}/f(m)^{N/m} (where N is the least common multiple of n and m) is such an invariant quantity and more complicated combinations of Fourier transform values f(n) may be used as well.

Nor is the invention limited to the use of Fourier transforms. For example signature computation unit 18 may use a number of quantities
Aₙ(τ)=∫dt Pₙ(t+τ)S(t)
(wherein the integral runs over one revolution period may be approximated by a summation), wherein Pₙ(t) (n=0,1, . . . ) are different base functions. In this case signature computation unit 18 may determine the maximum value Aₙ(τ) that occurs for any τ in a period of revolution. This value is does not change when the feedback signal F(t) is read with an offset dt due to rotation. Any set of base functions may be used Pₙ(t), for example and orthogonal set (so that ∫dt Pₙ(t)Pₘ(t) is zero when n is not equal to m). It may be noted that the amplitudes of the Fourier transform are a special case of such an invariant quantity, with a specific choice of base functions. Instead of the simple product any kind of function G may be used to determine the quantities:
Aₙ(τ)=∫dt G(Pₙ(t+τ),S(t))

(G(x,y)=−(x−y)² for example) and any other invariant criterion (e.g. distance between two zero crossings, curvature etc.) may be used to obtain an invariant measure.

In principle the base functions may be selected independent of the disk, so that the computation of the invariant quantities can be performed without using disk specific information, which makes it possible to implement computation of the quantities at a low architectural level in the player that does not require an interface to the data stream.

In another embodiment, the base functions may depend on a measured feedback signal that is determined when the disk has been made (this may be realized e.g. by using this measured feedback signal as a base function, or by selecting a number of base functions that are orthogonal to this measured feedback signal).

Hence it should be realized that the invention is not limited to any particular rotation invariant characteristic measure such as the amplitudes of the Fourier transform, although the latter are advantageous, since highly optimized hardware and software for computing these quantities is readily available. All described embodiments can be used in combination with any characteristic quantity.

For example, suppression of the first harmonic of the periodicity due to revolutions can be realized by applying a filter operation to the feedback signal first. In the examples give above, suppression of signals other that periodic signals is realized by using the function S(t), but of course computations using the feedback signal F(t) directly may be used as well, for example with periodic base functions to suppress frequencies other than harmonics of the revolution frequency. When variations in the computed quantities between different disks are not very small, signature computation unit 18 need not even limit itself to periodic components.

As another example replacement of the first harmonic by a measured value, for use during a session may simply be realized by first checking whether any characteristic measures computed from the feedback signal after suppressing the first harmonic match the reference values, then computing original values of the characteristic quantities from the same feedback signal without suppressing the first harmonic and subsequently repeatedly measuring feedback signals, computing new values of the characteristic measures from them and comparing these new values with the original values.

It will be realized that the use of the feedback signal for a plurality of revolutions (e.g. 10 or more or even 20 or more), combined with suppression of components of the feedback signal that do not have frequency of the revolution frequency or its harmonics makes it more readily possible to use difference between different disks that are very small, such as differences that naturally arise during manufacture, without deliberate manipulation. This is useful in itself, even if no rotation invariant characteristic measures are used. In combination with such characteristic measures the use of the feedback signal from multiples periods of revolution (preferably an integer number of periods) makes it more easily possible to obtain robust identification of disks without using knowledge about the particular disk during computation of the characteristic measures.

It should be realized that, although the invention makes it possible to use variations that arise spontaneously during manufacture of a disk to identify condition use of a particular disk, of course intentionally created variations may used as well. In one embodiment, variations due to a master may be used to condition use for all disks manufactured from the same master. In this case the thresholds for comparison (or rounding) are preferably set so high that differences between individual disks from the same master do not affect use. In a further embodiment, two levels of conditional use may be provided for, one conditional on matching with a more lenient threshold (to verify the master) and one conditional on matching with a less lenient threshold (to identify an individual disk).

1. An apparatus for processing data from an optical disk (20), which optical disk contains a track (22) that runs along a plurality of revolutions around a centre (21) of the disk (20), the apparatus comprising:
a reading unit (10) arranged to generate a data signal by decoding information from the track (21) and a track position signal that is indicative of the radial position and/or depth of the track (21 ), and/or jitter in the position of edges of bit signals from the track (21);
a signature computation unit (18) coupled to the reading (10) unit for receiving the track position signal, and arranged to compute, from the track position signal, values of plurality of characteristic measures so that the computed values are substantially invariant under a phase of disk rotation;
a data processing unit (14), coupled to the reading unit (10) for receiving the data signal, and to the signature computation unit (18), the data processing unit being arranged to control conditional use of the data signal dependent on the values computed for the characteristic measures.

2. An apparatus according to claim 1, wherein the signature computation unit (18) is arranged to perform the computation of the values of the characteristic measures using the track position signal in an interval that extends over a plurality of revolutions of the disk (20), suppressively filtering out frequency components of the track position signal which do not have a frequency corresponding to a revolution frequency of the disk or its harmonics.

3. An apparatus according to claim 1, wherein said plurality of revolutions contains at least ten revolutions.

4. An apparatus according to claim 2, wherein the signature computation unit (18) is arranged to compute amplitudes of a Fourier transform of the track position signal at a plurality of frequencies that are integer multiples of a frequency that corresponds to the revolution frequency of the disk, the data processing unit controlling use of the data signal dependent on the computed amplitudes.

5. An apparatus according to claim 2, wherein the signature computation unit (18) is arranged to perform the computation of the characteristic measures, suppressively filtering out a frequency component of the track position signal at a fundamental frequency corresponding to the revolution frequency of the disk.

6. An apparatus according to claim 2, wherein the data processing unit (14) is arranged to control conditional use of the data signal in a session, the signature computation unit (18) being arranged to perform the computation of at least one of the characteristic measures sensitive to an amplitude of a frequency component of the track position signal at a fundamental frequency corresponding to the revolution frequency of the disk (20), the data processing unit conditioning use of the disk (20) in the session on a match between the at least one of the characteristic measures and a reference value determined from the track position signal at a start of the session.

7. An apparatus according to claim 1, wherein the data processing unit (14) uses the computed values of the characteristic values as a key for decrypting at least part of the data.

8. An apparatus according to claim 1, wherein the data processing unit (14) is arranged to disable or enable copying of the data signal dependent on the computed values of the characteristic measures.

9. An apparatus for processing data from an optical disk (20), which optical disk (20) contains a track (22) that runs along a plurality of revolutions around a centre (21) of the disk (20), the apparatus comprising:
a reading unit (10) arranged to generate a data signal by decoding information from the track (21) and a track position signal that is indicative of the radial position and/or depth of the track (21), and/or jitter in the position of edges of bit signals from the track (21);
a signature computation unit (18) coupled to the reading unit (10) for receiving the track position signal, and arranged to determine a plurality of characteristic measures suppressively filtering out frequency components of the track position signal which do not have a frequency corresponding to a revolution frequency of the disk (20) or its harmonics;
a data processing unit (14), coupled to the reading unit for receiving the data signal, and to the signature computation unit (18), the data processing unit (14) being arranged to control conditional use of the data signal dependent on values computed for the characteristic measures.
